(19) United States
(12) Patent Application Publication
(10) Pub. No.: US 2016/0200891 A1
(43) Pub. Date: Jul. 14, 2016

(54) POROUS GELS AND METHODS FOR THEIR PREPARATION

(71) Applicant: POLYVALOR LIMITED PARTNERSHIP, Montreal (CA)

(72) Inventors: Nick Virgilio, Montreal (CA); Pierre Sarazin, Montreal (CA); Anne-Laure Esquirol, Montreal (CA)

(21) Appl. No.: 14/912,959

(22) PCT Filed: Aug. 22, 2014
(86) PCT No.: PCT/CA2014/050809

§ 371 Date: Feb. 19, 2016

Related U.S. Application Data
(60) Provisional application No. 61/868,782, filed on Aug. 22, 2013.

(51) Int. Cl. C08J 9/26; B29C 33/38; B01D 71/02; B29C 41/42; B29C 35/02; C01B 33/14; B29C 33/44

(52) U.S. Cl. CPC C08J 9/26; C01B 33/14; B29C 33/3814; B29C 33/3857; B29C 33/44; B29C 41/42; B29C 35/02; B01D 71/027; C08J 2333/14; C08J 2333/24; C08J 2383/04; C08J 2363/00; C08J 2305/00; C08J 2389/00; C08J 2305/04; B29L 2031/755

(57) ABSTRACT

There is provided a method for preparing a porous gel. The method comprises using a porous polymer template. The porous gel according to the invention has a porosity that is continuous throughout the whole volume of the gel and that is tunable in terms of pore size distribution and average pore diameter. The porous gel can be used in various application.

### FIELD OF THE INVENTION

The invention relates generally to porous gels and methods for their preparation. More specifically, the invention relates to porous gels wherein the porosity is continuous throughout the whole volume of the gel and is tunable in terms of pore size distribution and average pore diameter. The gels according to the invention are prepared using porous polymer templates.

### BACKGROUND OF THE INVENTION

Gels are materials comprising a major liquid phase, with mass or volume fractions often over 90%, and a precursor agent that forms a network with junction points that are called cross-links, throughout the volume of the liquid when gelling occurs. This network allows the immobilization of the liquid phase—water+gelatin gels being the prototypical example. Gels possess hybrid properties: (1) they are solid-like materials since they can display a certain elasticity, retain their shape (they do not easily flow or spread on a surface), can resist or elastically deform in answer to mechanical solicitations, and regain at least part of their initial shape when the stress is released; (2) they possess high, liquid-like diffusivity properties that are interesting for applications requiring molecular transport.

Currently in the art, the development of gels comprising 3-D microstructured networks of interconnected micro-channels or pores generally targets a number of fields including: (1) the development of vascularised materials for tissue engineering and cell culture applications—materials that can mechanically support cell development, allow their regeneration, and allow the diffusive and convective transport of dissolved gases and solutes between the environment and the cells within the material [1-3]; (2) materials for the development and testing of new therapeutic drugs (for example anticancer drugs); (3) the controlled delivery of substances encapsulated within the gel; (4) the development of materials for membranes, filtration, separation and chromatography applications [4]. The constraints and difficulties associated with the current preparation techniques of porous gels can be classified in two main categories. A first category includes techniques inherent to the preparation methods. A second category includes techniques associated with the targeted applications.

Methods for preparing gels comprising microstructured 3-D networks of (more or less) interconnected pores (also identified in the scientific literature as porous gels, microfluidic gels, gels embedded with pores and microchannels, macroporous gels, microengineered gels, microscale gels, gel scaffolds) are known in the art [1]. A few of these methods are presented below.

Particles leaching methods are based on gelling a solution in the presence of solid porogen particles—polymer particles, salt or sugar crystals, ice crystals, etc. [1,6,7]. These particles are subsequently extracted by leaching with an appropriate selective solvent, leaving the gel intact and which is comprised of porosities left by the particles extracted. These methods are practical and generally easy to set up. They allow the preparation of 3-D materials with potentially various shapes and sizes, with achievable average pore sizes that can range between 30 and 300 μm, and with porosities that can range between 20 and 50%. However, control of the porosity is a significant problem: (1) the particle size and distribution within the gels can be difficult to control; (2) pore interconnectivity and void fraction are two serious issues. The interconnectivity stems from particle-particle contacts. As a result, significant particle content is necessary to reach the percolation threshold, weakening the gel once the particles are extracted. Also, the interconnectivity arising from particle contact is often inhomogeneous since the area of contact can be much smaller than the particles themselves. As a result, the pore network is often inhomogeneous, difficult to control and fluid circulation can be restricted or limited. Finally some particles can remain in the gel matrix.

Liquid/liquid separation techniques have been employed to prepare dextran and polyacrylamide gels with adjustable average pore sizes (from sub-pm to about 100 μm as stated) and architectures [8,9]. However, the microstructural features of these gels in their hydrated state and their formation mechanisms remain currently unclear. Questions remain to be answered regarding the range of attainable pore sizes, the generality of the technique—whether it can be applied for many types of gels, and the expected transport properties.

Foaming methods are based on dissolving a gas under high pressure in a solution containing the precursor agent [10,11]. Releasing the pressure while gelling occurs allows the preparation of foamed gels. These methods, while relatively easy to set up, suffer from similar problems associated with the techniques based on particle leaching: difficulties to control the total void volume, pore size and pore interconnectivity. Particles that can generate gas have also been used to prepare such porous gels.

Cryogelation employs freeze-thaw cycles to create a porous gel (from near μm to over 100 μm average pore size) [5,12]. Typically, a diluted solution or gel at moderate temperature is subsequently brought to a temperature below the freezing point of the solvent, usually water. As ice crystals nucleate and grow, it concentrates the precursor agent in the remaining liquid solution, at which point gelling occurs, or the initial weak gel is concentrated and a stronger gel is formed. When the system is thawed, a gel comprising pores and/or cavities is obtained, which can be linked if the ice crystals finally touch each other during the freezing process.

Soft lithography processes [13-17] are a family of methods allowing the preparation of microfluidic gels. These techniques allow the preparation of patterns and shapes on 2-D surfaces by exposing part of the gel or of the precursor solution to certain types of radiations (often UV) while hiding other parts of the surface with masks. To realize 3-D structures, stacking of successive layers is generally performed. These methods allow the preparation of gels and microgels with complex shapes (including pores) with a very high resolution level. They are often used to prepare soft microfluidic devices or lab-on-chip devices. However, these methods can be difficult to scale up, require a costly set-up and do not directly yield 3-D structures. This is a major drawback since piling or stacking layers is time-consuming and do not result in robust samples. Furthermore, they are limited to radiation-sensitive materials.

Direct-write and rapid-prototyping methods (printing and writing with gelling “inks” or solutions, laser ablation) [18] allow the preparation of porous gels by successive stacking of layers generally formed from extruded microfibers or droplets that can be fused together to form a porous structure (resolution down to the μm and a porosity inferior to 90%). Laser ablation, on the other hand, consists in etching gels locally to create holes and channels with a very high resolution (from 5 μm to 1600 μm and a porosity of about 90%). These methods suffer from the similar problems associated with lithographic processes.

Processes for the preparation of co-continuous polymer blends are known in the art [19,20]. Also, the concept of using co-continuous blends to generate porous templates with narrow unimodal pore size distribution, centered around tunable average diameters, is generally known in art [25].

The methods known in the art for the preparation of porous gels are generally developed for the preparation of porous or microfluidic gels, for tissue engineering, materials for the development and testing of new therapeutic drugs (for example anticancer drugs), the controlled delivery of substances encapsulated within the gel, membranes or filtration/separation processes. These methods often involve hydrogels, for biocompatibility reasons [26]. Some known methods also involve porous dehydrated hydrogels, wherein the porosity is developed by drying the gel under vacuum (freeze-drying) [8].

There is a need for developing methods involving hydrogels and other types of gels such as organogels for example. There is also a need for developing methods that allow for a control of the shape and size of the porosity as well as the range of attainable average pore size.

### SUMMARY OF THE INVENTION

The inventors have discovered a method for preparing porous gels. The method of the invention uses porous polymer templates. The templates can be any polymer structure with pores that are interconnected throughout the volume of the structure, i.e. a polymer structure having a defined and continuous porosity. In embodiments of the invention, the porous polymer templates are made of co-continuous polymer blends. In other embodiments, the porous polymer templates are generated by additive manufacturing (AM) or 3-D printing.

The porous gels prepared by the method of the invention are comprised of 3-D interconnected pore networks throughout their whole volumes. The porous gels possess the following characteristics: (1) they are comprised of pores; (2) the pores are interconnected and form a 3-D network throughout the whole material; (3) the pore size distribution is unimodal, narrow and centered around an average pore diameter value that can be controlled and adjusted from about 0.5 μm to about 3.0 mm and above, and preferably between about 1 μm and about 1.5 mm; (4) the total volume of the pores can range from about 10% to over 90 vol %, and preferably between about 40% and about 60%. The method of the invention allows for the preparation of various types of gels. The method can be scaled up by using industrial equipments such as extruders. The method allows for the preparation of complex shapes by using, for example, injection molding or 3-D printing, mechanical tools and machines.

The invention thus provides for the following:
(1) A method for preparing a porous gel, comprising the steps of:
   (a) providing a porous polymer template;
   (b) injecting a precursor solution in the template, wherein the solution subsequently gels and a porous polymer and gel system is obtained; and
   (c) subjecting the porous polymer and gel system to an extraction process, wherein at least part of the polymer material is extracted and the porous gel is obtained.
(2) The method according to item (1), wherein step (a) comprises the steps of:
   (a1) preparing a co-continuous mixture of polymer material to obtain a polymer blend;
   (a2) annealing the polymer blend; and
   (a3) selectively extracting a portion of the polymer material to obtain the porous polymer template.
(3) A method according to item (2), wherein the polymer material comprises at least two polymers, the portion of the polymer material at step (a3) comprises one polymer and the polymer material at step (c) comprises at least one of the other polymers.
(4) A method for preparing a porous gel, comprising the steps of:
   (a1) preparing a co-continuous mixture of at least two polymers to obtain a polymer blend;
   (a2) annealing the polymer blend;
   (a3) selectively extracting at least one polymer to obtain the porous polymer template;
   (b) injecting a precursor solution in the template, wherein the solution subsequently gels and a porous polymer and gel system is obtained; and
   (c) subjecting the porous polymer and gel system to an extraction process, wherein at least part of the polymer material is extracted and the porous gel is obtained.
(5) A method for preparing a porous gel, comprising the steps of:
   (a1) preparing a co-continuous mixture of first and second polymers to obtain a polymer blend;
   (a2) annealing the polymer blend;
   (a3) selectively extracting the first polymer to obtain the porous polymer template;
   (b) injecting a precursor solution in the template, wherein the solution subsequently gels and a porous polymer and gel system is obtained; and
   (c) subjecting the porous polymer and gel system to an extraction process, wherein at least part of the polymer material is extracted and the porous gel is obtained.
(6) The method according to item (1), wherein step (a) comprises generating the porous polymer template by additive manufacturing (AM) or 3-D printing.
(7) A method for preparing a porous gel, comprising the steps of:
   (a) generating a porous polymer template by additive manufacturing (AM) or 3-D printing;
   (b) injecting a precursor solution in the template, wherein the solution subsequently gels and a porous polymer and gel system is obtained; and
   (c) subjecting the porous polymer and gel system to an extraction process, wherein at least part of the polymer material is extracted and the porous gel is obtained.
(8) The method according to any one of items (2) to (5), wherein step (a2) is performed under quiescent conditions.
(9) The method according to any one of items (2) to (5), wherein step (a2) is performed under a constant temperature.
(10) The method according to any one of items (2) to (5), wherein step (a2) is performed under a gradient temperature.
(11) The method according to any one of items (1) to (7), wherein step (b) comprises removing air from pores of the template.
(12) The method according to item (11), wherein step (b) comprises applying vacuum and/or pressure.
(13) The method of item (1), wherein at step (c), the polymer material is completely extracted and the porous gel obtained is substantially free of the polymer material.
(14) The method of item (1), wherein at step (c), the polymer material is partially extracted and the porous gel obtained comprises the polymer material.
(15) The method according to any one of items (1) to (14), further comprising the step of: (d) freeze-drying the porous gel obtained.
(16) The method according to any one of items (1), (2), (6) and (7), wherein polymers in the polymer material are selected from: polystyrene (PS), poly(methyl methacrylate) (PMMA), poly(D, L or DL)lactide (PLA), polycaprolactone (PCL), polyethylene oxide (PEO), polyethylene glycol (PEG), polypropylene (PP), polyethylene (PE), high density polyethylene (HDPE), low density polyethylene (LDPE), linear low density polyethylene (LLDPE), polybutadiene (PBD), ethylene-propylene rubber (EPR), ethylene-propylene-diene monomer (EPDM), polycarbonate (PC), polyamides (PA), polyglycolide (PGA), polyvinyl alcohol (PVOH or PVA), polyvinyl acetate (PVAc), polysiloxanes, polyethylene terephthalate (PET), styrene-acrylonitrile copolymers (SAN), polyvinylidene fluoride (PVDF), polybutylene succinate (PBS), polyether amides (PEBA), acrylonitrile butadiene styrene (ABS), polyhydroxyalcanoates, polyesters, polyanhydrides, copolymers thereof, atactic forms thereof when applicable, isotactic forms thereof when applicable, syndiotactic forms thereof when applicable, and stereoisomers thereof when applicable.
(17) The method according to any one of items (2) to (5), wherein the polymers are selected from: polystyrene (PS), poly(methyl methacrylate) (PMMA), poly(D, L or DL)lactide (PLA), polycaprolactone (PCL), polyethylene oxide (PEO), polyethylene glycol (PEG), polypropylene (PP), polyethylene (PE), high density polyethylene (HDPE), low density polyethylene (LDPE), linear low density polyethylene (LLDPE), polybutadiene (PBD), ethylene-propylene rubber (EPR), ethylene-propylene-diene monomer (EPDM), polycarbonate (PC), polyamides (PA), polyglycolide (PGA), polyvinyl alcohol (PVOH or PVA), polyvinyl acetate (PVAc), polysiloxanes, polyethylene terephthalate (PET), styrene-acrylonitrile copolymers (SAN), polyvinylidene fluoride (PVDF), polybutylene succinate (PBS), polyether amides (PEBA), acrylonitrile butadiene styrene (ABS), polyhydroxyalcanoates, polyesters, polyanhydrides, copolymers thereof, atactic forms thereof when applicable, isotactic forms thereof when applicable, syndiotactic forms thereof when applicable, and stereoisomers thereof when applicable.
(18) The method according to item (5), wherein the first polymer is selected from polystyrene (PS), poly(methyl methacrylate (PMMA), ethylene-propylene rubber (EPR), polycaprolactone (PCL), and polyethylene oxide (PEO).
(19) The method according to item (5), wherein the second polymer is selected from poly(D, L or DL)lactide (PLA), polyethylene (PE), poly(methyl methacrylate (PMMA), polycaprolactone (PCL), polyvinyl alcohol (PVOH or PVA), polyethylene oxide (PEO), and styrene-acrylonitrile copolymer (SAN).
(20) The method according to item (5), wherein the first polymer is polystyrene and the second polymer is polylactide.
(21) The method according to item (5), wherein a combination first polymer/second polymer is selected from: polystyrene/polyethylene, poly(methyl methacrylate)/polyethylene, polystyrene/poly(methyl methacrylate), ethylene-propylene rubber/poly(methyl methacrylate), ethylene-propylene rubber/polyethylene, polycaprolactone/polylactide, polyethylene oxide/polycaprolactone, polyethylene oxide/polyvinyl alcohol, poly(methyl methacrylate)/polylactide, polyethylene oxide/polylactide, polycaprolactone/polyvinyl alcohol, polystyrene/polycaprolactone, polystyrene/polyethylene oxide, poly(methyl methacrylate)/styrene-acrylonitrile copolymer, and poly(butylene succinate)/polyethylene oxide.
(22) The method according to item (5), wherein the first and second polymers are used in a proportion of about 50/50 vol %.
(23) The method according to any one of items (2) to (5), wherein the extraction solvents at steps (a3) and (c) are selected from: cyclohexane, benzoic acid, chloroform, dichloromethane, toluene, hexane, acetone, ethanol, methanol, water, hydrochloric acid, 1-propanol, acetic acid, sulfuric acid, benzene, tetrahydrofuran, 1,4-dioxane, isopropanol, dimethylformamide, nitric acid, pentane, cyclopentane, diethyl ether, ethyl acetate, acetonitrile, dimethyl sulfoxide, formic acid, 1-butanol, 2-butanol, petroleum ether, heptane, methyl tert-butyl ether, tert-butanol, methylbutylacetone, isobutanol, butanone, isopentyl alcohol, diethyl acetone, 1-octanol, p-xylene, m-xylene, o-xylene, dimethoxyethane, ethylene glycol, glycerol, and mixtures thereof.
(24) The method according to any one of items (2) to (5), wherein the extraction solvent at step (a3) is selected from water, toluene, cyclohexane and mixtures thereof; and the extraction solvent at step (c) is chloroform or water.
(25) The method according to any one of items (2) to (5), wherein the extraction solvent at step (a3) is cyclohexane, and the extraction solvent at step (c) is chloroform.
(26) The method according to any one of items (1) to (5), wherein the precursor solution comprises a precursor agent selected from: natural macromolecules (polysaccharides, proteins, gums and their combinations, etc.), synthetic macromolecules (polyacrylates, polyacrylamides, associative polymers, polydimethylsiloxanes, etc.), low molecular weight gelators (fatty acid derivatives, steroid derivatives, sugar-based derivatives, etc.), low molecular weight molecules that react to form molecular networks (such as epoxides), low molecular weight molecules that react to form fibrillar networks (for example 12-hydroxyoctadecanoic acid) or networks of micro/nano-particles (sodium silicate, tetraorthosilicate, aluminum hydroxide, etc.).
(27) The method according to any one of items (1) to (5), wherein the precursor solution is selected from: solutions of water with natural polymers, solutions of water with synthetic monomers and/or polymers, solutions of organic liquids with low molecular weight gelators, monomers or polymers, solutions or liquids containing molecules that can react to form molecular networks, fibrillar networks or networks of micro/nano-particles, and mixtures thereof.
(28) The method according to any one of items (1) to (5), wherein the porous gel is a physically cross-linked gel (ex. agar), an ionically or physico-chemically cross-linked gel (ex. alginate), a chemically cross-linked gel (ex. poly(hydroxyethyl methacrylate)), poly(N-isopropylacrylamide), a hydrogel, an organogel, or a combination thereof.
(29) The method according to any one of items (2) to (5), wherein step (a) further comprises subjecting the polymer blend to a step of shaping and/or molding between steps (a1) and (a2).
(30) The method of item (1), wherein a distribution of pore diameters of the gel is controlled by a porous polymer template selection.
(31) The method according to item (1), wherein the porous polymer template has a distribution of pore diameters that is unimodal.
(32) A method for preparing a porous polymer and gel system, comprising the steps of:
   (a) providing a porous polymer template; and
   (b) injecting a precursor solution in the template, wherein the solution subsequently gels and the porous polymer and gel system is obtained.
(33) The method according to item (32), further comprising the step of: (c1) subjecting the porous polymer and gel system obtained at step (b) to an extraction process, wherein the polymer material is partially extracted.
(34) The method according to item (32) or (33), further comprising the step of: (d) freeze-drying the porous polymer and gel system obtained.
(35) The method according to item (34), further comprising subjecting the freeze-dried porous polymer and gel system to hydration, and then subjecting the system to one or more further extraction processes, wherein at least part of the polymer material is extracted.
(36) A porous gel obtained by the method as defined in any one of items (1) to (31).
(37) The porous gel according to item (36), which comprises a 3-D fully interconnected pore network throughout its volume.
(38) The porous gel according to item (36) or (37), wherein a total void or pore volume fraction is about 10 to more than 90 vol %.
(39) The porous gel according to item (36) or (37), wherein a total void or pore volume fraction is between about 40 and about 60 vol %.
(40) The porous gel according to item (36) or (37), having an average pore size diameter ranging from about 0.5 μm to about 3.0 mm.
(41) The porous gel according to item (36) or (37), having an average pore size diameter ranging from about 1 μm to about 1.5 mm.
(42) The porous gel obtained by the method as defined in item (10), having a gradient average pore size.
(43) The porous gel obtained by the method as defined in item (31), having a distribution of pore diameters that is unimodal.
(44) Use of the porous gel as defined in any one of items (36) to (43), as material for supporting cell development.
(45) Use of the porous gel as defined in any one of items (36) to (43), as a membrane or as filtration or separation material.
(46) Use of the porous gel as defined in any one of items (36) to (43), for reproducing natural structures (skin, bones).
(47) Use of the porous gel as defined in any one of items (36) to (43), as material for the development and testing of new therapeutic drugs (anticancer drugs).
(48) Use of the porous gel as defined in any one of items (36) to (43), for the controlled-delivery of a substance, wherein the substance is encapsulated therein.
(49) Use of the porous gel obtained by the method as defined in item (15), wherein the freeze-dried porous gel is subjecting to hydration prior to the use, and wherein the use of the porous gel is: as material for supporting cell development, as a membrane, as filtration or separation material, for reproducing natural structures (skin, bones), as material for the development and testing of new therapeutic drugs (anticancer drugs), or for the controlled delivery of a substance encapsulated therein.
(50) A porous polymer and gel system obtained by the method as defined in any one of items (32) to (35).
(51) Use of the polymer and gel system obtained by the method as defined in any one of items (32) to (35), in the development of materials for supporting cell development, membranes, filtration or separation materials, materials for the development and testing of new therapeutic drugs (anticancer drugs); in the process of reproducing natural structures (skin, bones); in the controlled-delivery process of an encapsulated substance.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1: Schematic illustration of the successive steps that are followed to prepare porous gels from co-continuous melt-processed polymer blends (1a-d) or from a porous polymer template generated by additive manufacturing (AM) or 3-D printing (1 b-d). 1 a. Initial co-continuous blend of polymer A (black) and polymer B (grey) after melt-processing and quiescent annealing. (1) The A phase is extracted to yield porous mold B, which can also be obtained by additive manufacturing or 3-D printing. (2) Injection of precursor solution. (3) Gel formation by in situ gelling to yield mold B filled with gel (red). (4) Extraction of the B phase to yield the porous gel.

FIG. 2: SEM micrographs showing the internal microstructure of porous polylactide (PLA) materials prepared with 50/50% vol PS/PLA blends: a) tₐₙₙₑₐₗ=0 min (as prepared in internal mixer); b) tₐₙₙₑₐₗ=10 min; c) tₐₙₙₑₐₗ=30 min; d) tₐₙₙₑₐₗ=60 min and e) tₐₙₙₑₐₗ=90 min. The samples are initially annealed and microtomed, followed by PS extraction with cyclohexane. The microtomed surface is comprised within the dotted line. The inset in (a) is a close-up to show the porosity.

FIG. 3: a) Injection system: modified syringe with two pistons and a small hole in the middle to replace air by the precursor solution within the pores; b) Picture of the cross-section of a porous PLA polymer template (tₐₙₙₑₐₗ=10 min), cut right in the middle of the sample after the injection of the agar solution and its gelling by cooling at room temperature, showing it to be completely filled with the solution (stained in red for identification purpose); c) similar picture as in (b) but with an alginate solution (stained in blue) in a PLA template (tₐₙₙₑₐₗ=30 min) (gelling occurs by the addition of calcium ions); d) optical microscopy picture of the porous PLA material showing the pore network now filled with the agar gel (red); e) same as (d) but with an alginate gel (in blue); f) optical microscopy picture showing the initial porous PLA polymer with an empty pore network (tₐₙₙₑₐₗ=30 min); g) Picture of the cross-section of a porous PLA template (tₐₙₙₑₐₗ=10 min) showing alginate-filled (in blue) and unfilled (in white) regions within the pore network.

FIG. 4: a) Picture of a 1 cm³ porous PLA polymer template (tₐₙₙₑₐₗ=60 min) before gel injection and b) of the final porous agar gel. The scale shows that the dimensions are nearly unchanged after the preparation; c) Optical microscopy picture of a porous agar gel (t ₐₙₙₑₐₗ=60 min). The surface texture is due to the presence of a porosity within the material; d) Porous

FIG. 5: 2-D X-ray micrographs and 3D reconstructions from X-ray micrographs of an agar (5a and c) and an alginate (5b and d) porous gels prepared with PLA molds (tₐₙₙₑₐₗ=60 min, mold extracted).

FIG. 6: a) Porous polyvinyl alcohol (PVOH) template (tₐₙₙₑₐₗ=30 min), obtained from PCL/PVOH co-continuous blend (PCL extracted with toluene), before injection of solution comprised of toluene and dissolved 12-hydroxystearic acid (or 12-hydroxyoctadecanoic acid) molecular gelator (HOA, 1%); b) porous organogel of toluene and 1% HOA after dissolution of PVOH template shown in a) with water; c) porous organogel comprised of canola oil and 2% HOA, after dissolution of PVOH template with water; d) comparison between a non-porous (left), and a porous (right) poly(N-isopropylacrylamide) hydrogels. The porous gel was obtained by chemically polymerizing and crosslinking N-isopropylacrylamide in the pores of a PLA mold after injection of the solution containing the monomers, initiators and crosslinkers (chemically cross-linked gel), followed by selective extraction of the polymer mold with chloroform.

FIG. 7: a) 50/50%vol. PS/PLA bar (0.95 cm×1.25 cm×6.3 cm) prepared by extrusion followed by injection molding; b) Porous PLA bar prepared by quiescent annealing during 30 min of the PS/PLA bar displayed in (a) followed by selective extraction of the PS phase with cyclohexane; c) Porous agar gel obtained with the PLA mold displayed in (b), after injection of the precursor solution, in situ gelling, and the extraction of the PLA polymer with chloroform.

FIG. 8: a) Porous agar gel prepared with a PLA mold (tₐₙₙₑₐₗ=60 min); b) sample in (a) subsequently freeze-dried for 2 days and c) sample in (b) rehydrated with water. The sample dimensions are about 0.8 cm each side. Note that the macroscopic dimensions are nearly unchanged after freeze-drying and rehydration.

FIG. 9: a) Cubic porous PLA mold obtained by additive manufacturing (3.375 cm³, 1 mm pore size); b) Cubic porous PLA mold obtained by additive manufacturing (8 cm³, 1.5 mm pore size); c) Porous mold in (b) filled with sodium alginate hydrogel; d) Porous sodium alginate hydrogel after extraction of the PLA mold with chloroform; e) Comparison of cubic porous PLA molds obtained by additive manufacturing. Top row from left to right: one 8 cm³, 1.5 mm pore size cube (as in (a)), followed by five 3.375 cm³, 1 mm pore size cubes (as in (b)). Bottom row: five 1 cm³, 0.5 mm pore size cubes. The pores can be seen at the top surface of the cubes.

### DESCRIPTION OF ILLUSTRATIVE EXAMPLES AND EMBODIMENTS

The invention relates to a method for preparing porous gels. The method uses porous polymer templates. The templates can be any polymer structure with pores that are interconnected throughout the volume of the structure, i.e., a polymer structure having a defined and continuous porosity. In embodiments of the invention, the porous polymer templates are made of co-continuous polymer blends. In other embodiments, the porous polymer templates are generated by additive manufacturing (AM) or 3-D printing.

The porous gel obtained by the method of the invention comprises a 3-D network of interconnected pores. The porosity is continuous throughout the whole volume of the gel. The pores are fully interconnected. The method can be used for various types of gels and allows for a control of the shape and size of the pores as well as the range of attainable average pore size.

As used herein, the term “polymer blend” refers to a mixture of two or more polymers of different structures.

As used herein, the term “co-continuous” refers to a blend wherein each polymer phase is essentially continuous through the polymer blend obtained.

As used herein, the term “porous” refers to the property of a material having pores, i.e. void spaces.

As used herein, the term “porosity” refers to the void volume in a porous article.

As used herein, the term “additive manufacturing (AM)” refers to a process for making a three-dimensional object of any shape from a 3-D model or from an electronic data source, in which successive layers of material are laid down under computer control.

As used herein, the term “gel” refers to a solid comprised of a liquid phase immobilized by a 3-D network that is formed by precursor molecules.

As used herein, the term “precursor” refers to a constituent that transforms a liquid solution into a solid-like material when it forms a network comprising junctions or cross-links that can be permanent or temporary.

As used herein, the term “precursor solution” (in certain cases called a “sol”) refers to a liquid solution that contains the precursor molecules before its transformation to a gel state.

As used herein, the term “distribution” refers to a set of numbers (for example, the pore sizes or pore diameters) and their frequency of occurrence, collected from measurements over a statistical population.

As used herein, the term “unimodal distribution” refers to a distribution having a single local peak.

As used herein, the term “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used herein, the terms “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein the term “about” is used to indicate that a value includes an inherent variation of error for the device or the method being employed to determine the value.

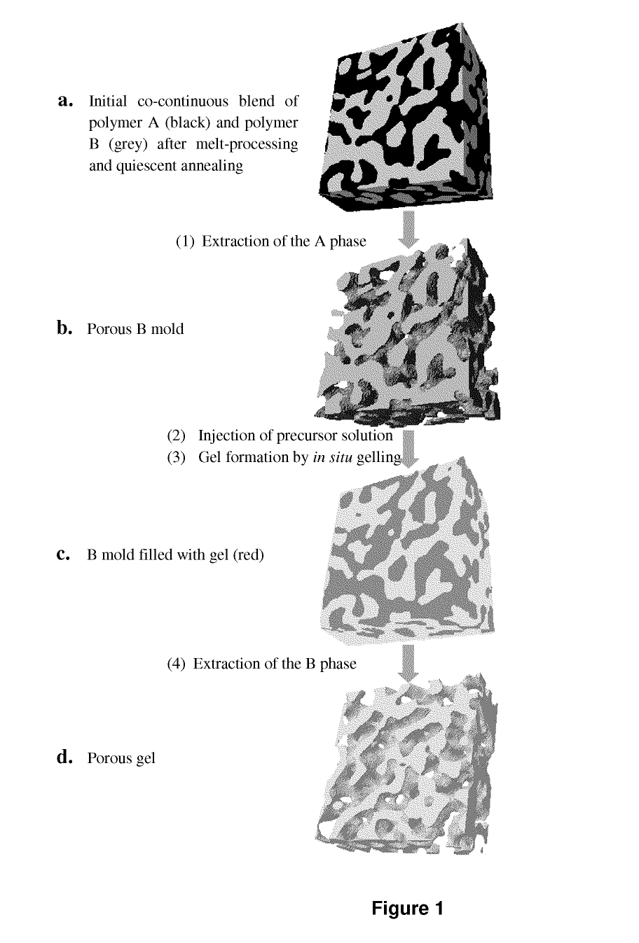

The method according to the invention comprises a step of preparing a porous polymer template, a step of injecting a precursor solution in the template, which is followed by gelling of the solution, and a step of selectively extracting, at least partially, the polymer to obtain the porous gel. This is outlined in FIG. 1b-d.

In certain embodiments of the invention, preparation of the porous polymer template comprises a step of preparing a co-continuous mixture of at least two polymers to obtain a polymer blend, a step of annealing the polymer blend, and a step of selectively extracting at least one polymer. This is outlined in FIG. 1a.

In other embodiments of the invention, the step of preparing a porous polymer template comprises generating the template by additive manufacturing (AM) or 3-D printing.

The porous polymer template so generated is used for the preparation of the porous gel as outlined in FIG. 1 b-d.

The inventors have discovered that, surprisingly, under certain conditions, the porous template can be entirely filled with the precursor solution and subsequently the template can be dissolved without altering the gel.

The steps involved in the method according to the invention are described in detail below.

1. Preparation of Immiscible Co-Continuous polymer Blends (Example 1)

The blends according to the invention comprise at least two immiscible polymer phases that are continuous throughout their volumes—these are co-continuous blends. The phases form interpenetrated networks with near micron-size characteristic dimensions (average domain diameter). The co-continuous polymer blends can be prepared with a variety of polymers, including but not limited to: polystyrene (PS), poly(methyl methacrylate) (PMMA), poly(L, D, or DL)lactide (PLA), polycaprolactone (PCL), polyethylene oxide (PEO), polyethylene glycol (PEG), polypropylene (PP), polyethylene (PE), high density polyethylene (HDPE), low density polyethylene (LDPE), linear low density polyethylene (LLDPE), polybutadiene (PBD), ethylene-propylene rubber (EPR), ethylene-propylene-diene monomer (EPDM), polycarbonate (PC), polyamides (PA), polyglycolide (PGA), polyvinyl alcohol (PVOH or PVA), polyvinyl acetate (PVAc), polysiloxanes, polyethylene terephthalate (PET), styrene-acrylonitrile copolymers (SAN), polyvinylidene fluoride (PVDF), polybutylene succinate (PBS), polyether amides (PEBA), polyhydroxyalcanoates, polyesters, polyanhydrides, etc., their copolymers, their atactic forms when applicable, their isotactic forms when applicable, their syndiotactic forms when applicable, their stereoisomers when applicable.

In embodiments of the invention, the co-continuous polymer blends are prepared with polystyrene (PS) and polylactide (PLA).

As will be understood by a skilled person, other co-continuous polymer blends can also be prepared. The following various combinations may also be used, including but not limited to: polystyrene/polyethylene, poly(methyl methacrylate)/polyethylene, polystyrene/poly(methyl methacrylate), ethylene-propylene rubber/poly(methyl methacrylate), ethylene-propylene rubber/polyethylene, polycaprolactone/polylactide, polyethylene oxide/polycaprolactone, polyethylene oxide/polyvinyl alcohol, poly(methyl methacrylate)/polylactide , polyethylene oxide/polylactide, polycaprolactone/polyvinyl alcohol, polystyrene/polycaprolactone, polystyrene/polyethylene oxide, poly(methyl methacrylate)/styrene-acrylonitrile copolymer, and poly(butylene succinate)/polyethylene oxide.

Moreover as will be understood by a skilled person, the polymers to be combined together are selected such that one can be selectively extracted leaving the other intact.

If it is desired to increase the microstructural complexity of the co-continuous blends, additional immiscible phases or interfacial modifiers can be added (ex. ternary co-continuous blends and/or block copolymers [21,22]). In this case, the blends are melt-processed in an internal mixer (laboratory-scale) or with an extruder (industrial scale). Other techniques may also be used to prepare the co-continuous polymer blends. Such techniques are for example liquid/liquid separation (such as spinodal decomposition).

This initial step of preparing the co-continuous polymer blend as described allows for (1) control over the void or pore volume fraction in the final porous gel and (2) control (in part) over its resulting microstructure.

2. Quiescent (Static) Annealing and Shaping of the polymer Blends (Example 2)

The step of quiescent annealing allows for control over the average size of the polymer phase domains [23], and ultimately over the average pore size diameter within the gels. The blends are annealed under quiescent conditions over the softening/melting temperature of the materials, i.e., in their liquid state. Coalescence and coarsening of the phases occur via capillary instabilities (Rayleigh instabilities) due to the interfacial tension existing at the interfaces of the polymer phases. This leads to the gradual increase of the average polymer domains size. During this process, the domains remain interconnected within the volume. This quiescent coarsening step allows for control over the average size of the domains from sub-pm to near mm dimensions, and ultimately over the average pore size within the final porous gel materials. It also allows for control over the final microstructure of the gel materials and could be used to control the porous gels internal surface properties.

As will be understood by a skilled person, the quiescent annealing conditions are selected based on the polymers in the blends. Such conditions involve for example temperatures (surfaces and surrounding medium), durations, nature of the surfaces in contact with the polymers, nature of the surrounding atmosphere, types of quenching following annealing. In embodiments of the invention using a blend of polystyrene (PS) and polylactide (PLA), the conditions are a temperature of 190° C., durations of 0 (unannealed blend), 10, 30, 60 and 90 min, normal atmosphere, surfaces of polyimide, quenching in cold water.

During the annealing step, a gradient temperature can be applied [24]. This would allow for the preparation of porous gels having gradient average pore sizes.

Preceding and/or following the quiescent annealing procedure, the polymer blends can be shaped with a variety of mechanical tools and equipments to obtain various shapes.

3. Selective Extraction of a polymer Phase to Obtain a Porous polymer Template for Gel Molding (Example 3)

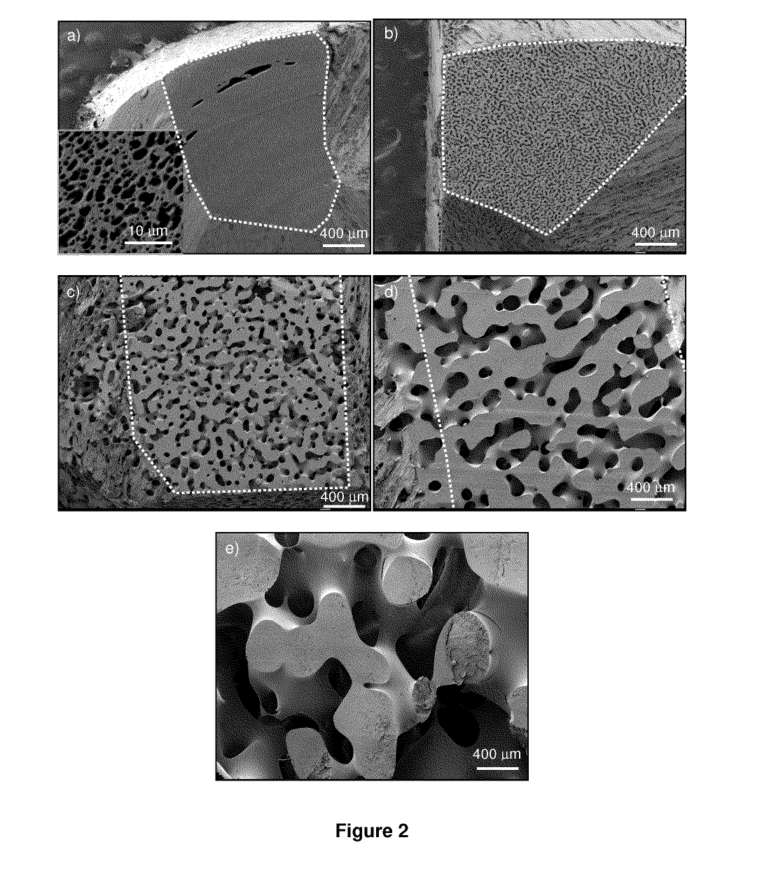

This step follows quiescent annealing and shaping, and consists in selectively extracting, with an appropriate solvent, at least one of the continuous polymer phases within the co-continuous polymer blend to obtain a porous polymer template (FIG. 2).

FIG. 2 shows porous polylactide (PLA) polymers prepared with co-continuous polystyrene (PS). PS/PLA 50/50%vol binary polymer blends are annealed for various times—0, 10, 30, 60 and 90 minutes. The PS phase has been selectively extracted with cyclohexane after quiescent annealing. The average pore size increases from about 3 μm (FIG. 2a) to near 500 μm (FIG. 2e). The amount of extracted PS (in mass %), the specific surface of the porous PLA materials and the average pore size diameter (as measured by image analysis) are reported in Table 1. While the amount of extracted PS is near 100% in all cases, the specific surface decreases as a function of annealing time (t anneal) from about 5800 cm⁻¹ to less than 50 cm⁻¹, confirming the internal coarsening of the polymer phases during annealing. This method allows for the preparation of a template outlining a unimodal distribution set at a predefined target average pore diameter, as defined in U.S. Pat. No. 8,007,823 [25].

TABLE 1
Average PS phase continuity measured by gravimetric analysis,
specific surface of the porous PLA materials as a function of
annealing time (tₐₙₙₑₐₗ), and average pore size diameter.

| Annealing | PS continuity | Specific | Average pore size² |
|---|---|---|---|
| time (min) | (%) | surface¹ (cm⁻¹) | (μm) |
| 0 | 96 ± 3 | 5800 ± 300 | 3 |
| 10 | 95 ± 2 | 900 ± 100 | 22 |
| 30 | 97 ± 1 | 198 ± 3 | 101 |
| 60 | 96 ± 2 | 100 ± 10 | 200 |
| 90 | 101 ± 2 | 45 ± 3 | 444 |

¹[27].
²[28].

The extraction does not affect the original dimensions of the remaining polymer material nor the remaining polymer phases. The inventors subsequently obtain polymer materials comprising 3-D networks of fully interconnected pores. The characteristic dimensions of these porous networks are controlled by the volume fractions of the constituents (see step 1), the quiescent annealing time (see step 2), and the processing conditions. The porous polymer obtained (porous polymer template) acts as a mold for the preparation of the porous gel.

In embodiments of the invention, cyclohexane is used for this initial extraction.

As will be understood by a skilled person, various solvents as well as acids and bases may also be used, including but not limited to cyclohexane, benzoic acid, chloroform, dichloromethane, toluene, hexane, acetone, ethanol, methanol, water, hydrochloric acid, 1-propanol, acetic acid, sulfuric acid, benzene, tetrahydrofuran, 1,4-dioxane, isopropanol, dimethylformamide, nitric acid, pentane, cyclopentane, diethyl ether, ethyl acetate, acetonitrile, dimethyl sulfoxide, formic acid, 1-butanol, 2-butanol, petroleum ether, heptane, methyl tert-butyl ether, tert-butanol, methylbutylacetone, isobutanol, butanone, isopentyl alcohol, diethyl acetone, 1-octanol, p-xylene, m-xylene, o-xylene, dimethoxyethane, ethylene glycol, glycerol and mixtures thereof.

Also as will be understood by a skilled person, the solvent is selected such that at least one polymer is extracted while at least one polymer is not extracted.

4. Injection of the Precursor Solution in the Porous polymer Template (Example 4)

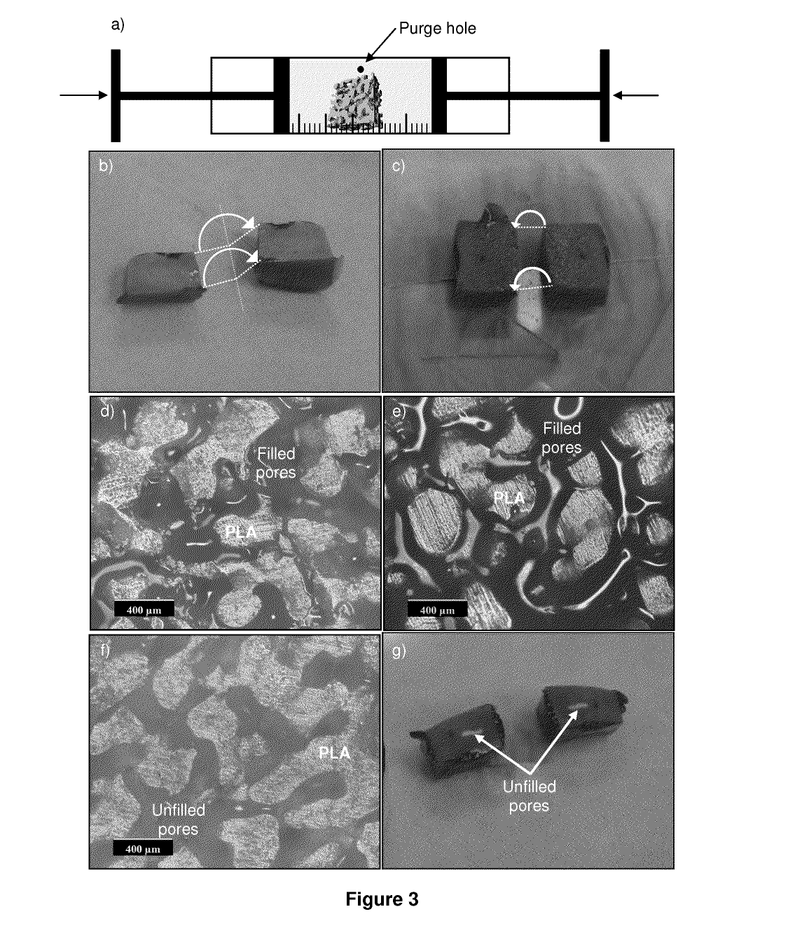

This step consists in injecting a precursor solution containing the precursor agent inside the porous polymer material. The injections were realized with a 10 ml syringe that has been modified with two pistons and a thin hole that acts as a purge to evacuate the air contained initially within the pores (FIG. 3a). Since the pores of the porous polymer template are interconnected, i.e., the porosity is continuous through the volume of the template, the entire porosity is filled with the solution. The solution subsequently gels in situ in the porous polymer template.

FIG. 3b-e shows porous polymers filled with precursor solutions (after injection), and before injection of the precursor solution (FIG. 3f). Two different types of gels are prepared as demonstrations: a physically cross-linked (gelling induced by a temperature decrease) hydrogel (agar) and an ionically (or physico-chemically) cross-linked (gelling induced by divalent calcium ions) hydrogel (alginate). The precursor solutions completely fill the polymers, as the cross-sections of the samples cut in two pieces illustrate (FIG. 3b and c). Optical microscopy close-up images show the porous polymers injected with respectively the agar and alginate solutions (FIG. 3d and e), and the empty porous polymer mold (FIG. 3f). For very small pores, a relatively high pressure is required to completely fill the samples. FIG. 3g shows a partially filled porous polymer template (tₐₙₙₑₐₗ=10 min).

In embodiments of the invention, a precursor solution is a solution of water with dissolved agar or sodium alginate (gelators). As will be understood by a skilled person, other precursor solutions may also be used, including but not limited to: solutions of water with natural polymers, solutions of water with synthetic monomers and/or polymers, solutions of organic liquids with low molecular weight gelators, monomers or polymers, solutions or liquids containing molecules that can react to form molecular networks, fibrillar networks or networks of micro/nano-particles, and mixtures thereof.

In embodiments of the invention a precursor agent is agar or sodium alginate. As will be understood by a skilled person, other precursor agents may also be used, including but not limited to: natural macromolecules (polysaccharides, proteins, gums and their combinations, etc.), synthetic macromolecules (polyacrylates, polyacrylamides, associative polymers, polysiloxanes, etc.), low molecular weight gelators (fatty acid derivatives, steroid derivatives, sugar-based derivatives, etc.), low molecular weight molecules that react to form molecular networks (such as epoxides), low molecular weight molecules that react to form fibrillar networks (for example 12-hydroxyoctadecanoic acid) or networks of micro/nano-particles (sodium silicate, tetraorthosilicate, aluminum hydroxide, etc.).

The gel can be aqueous (hydrogel) or organic (organogel). Also, the gel can be chemically cross-linked (ex. poly(hydroxyethyl methacrylate, poly(N-isopropylacrylamide), polysiloxanes, epoxies, etc), physically cross-linked (ex. agar, gelatin), ionically or physico-chemically cross-linked (ex. alginate), formed by stacking/piling of micro/nanoparticles (silica or metal organic gels), etc.

Using a porous polymer template or mold allows for the preparation of various types of gel. The polymer template constitutes a mold in which the precursor solution gels afterwards. This mold imparts the gel its final dimensions and porosity once the remaining polymer/s is/are extracted.

5. Selective Extraction of the Remaining polymer(s) to Obtain a Porous Gel (Example 5)

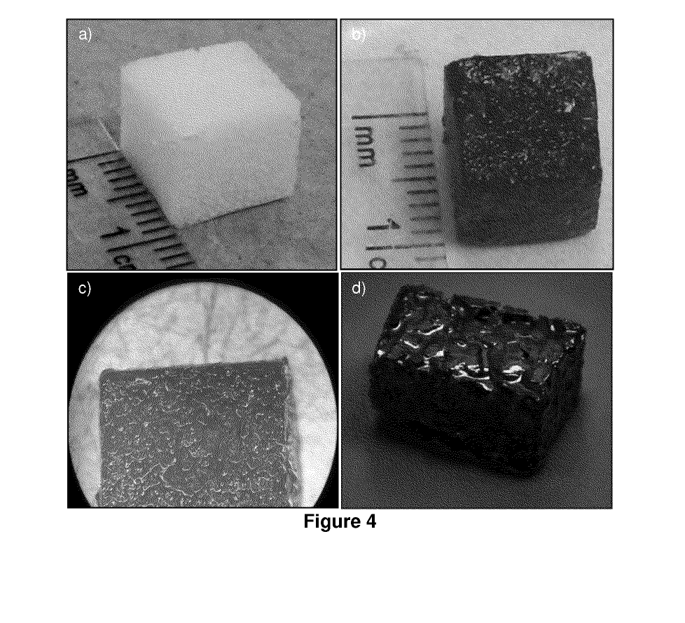

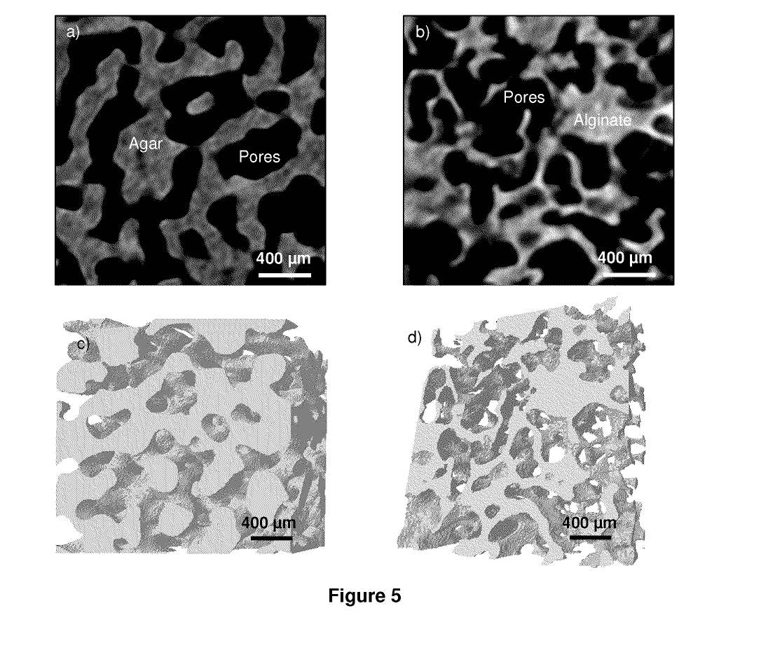

This step consists in using a selective solvent to dissolve and extract the remaining polymer/s (polymer mold) leaving the gel phase intact. A porous gel is thus obtained. The pores are left by the extraction of the remaining polymer phase/s. The macroscopic dimensions of the gels remain intact (FIG. 4). The characteristic dimensions of the pores match those of the extracted polymer/s domains (FIG. 5).

To further characterize the porosity of the porous gels after the final polymer/s extraction, the inventors characterized the samples by optical microscopy and 3-D X-ray microtomography (FIGS. 4 and 5). The specific surface and average pore diameter of the porous gel displayed in FIGS. 5a and c are 70±4 cm⁻¹ and 285 μm (agar gel, tₐₙₙₑₐₗ=60 min, specific surface and average pore size calculated with the same image analysis technique used for the polymer scaffolds, Table 1).

In embodiments of the invention, a solvent used in this final extraction step is chloroform.

As will be understood by a skilled person, other solvents, acids and bases may also be used, such as for example cyclohexane, benzoic acid, chloroform, dichloromethane, toluene, hexane, acetone, ethanol, methanol, water, hydrochloric acid, 1-propanol, acetic acid, sulfuric acid, benzene, tetrahydrofuran, 1,4-dioxane, isopropanol, dimethylformamide, nitric acid, pentane, cyclopentane, diethyl ether, ethyl acetate, acetonitrile, dimethyl sulfoxide, formic acid, 1-butanol, 2-butanol, petroleum ether, heptane, methyl tert-butyl ether, tert-butanol, methylbutylacetone, isobutanol, butanone, isopentyl alcohol, diethyl acetone, 1-octanol, p-xylene, m-xylene, o-xylene, dimethoxyethane, ethylene glycol, glycerol and mixtures thereof.

Also, as will be understood by a skilled person, the solvent at this step is selected such that it selectively extracts the remaining polymer/s while leaving the gel intact. Moreover, as will be understood by a skilled person, the solvent used at this step is different from the solvent used in the first extraction step.

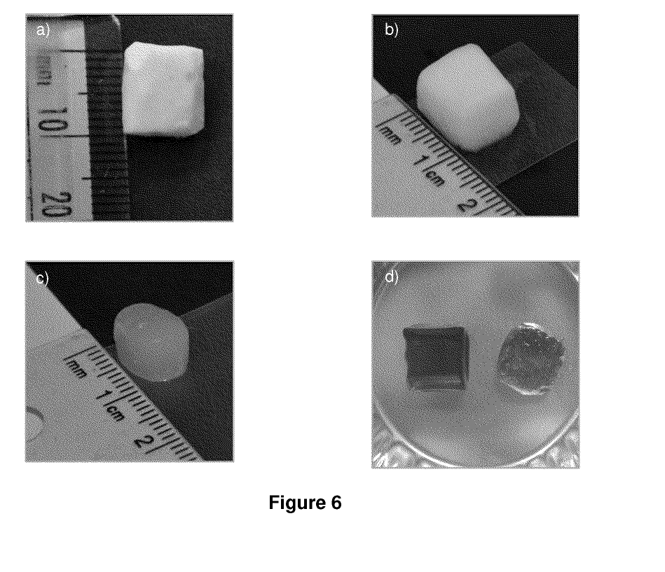

The method according to the invention can allow for the preparation of a wide variety of porous gels (FIG. 6): the gel can be chemically cross-linked (ex. poly(hydroxyethyl methacrylate), poly(N-isopropylacrylamide), polysiloxanes, epoxies, etc.), physically cross-linked (ex. agarose, gelatin), ionically or physico-chemically cross-linked (ex. alginate), formed by stacking/piling of micro/nanoparticles (silica or metal organic gels), etc.

6. Scale-Up of the Method by Melt Extrusion and Molding Processes to Obtain polymer Templates with Complex 3-D Shapes (Example 6)

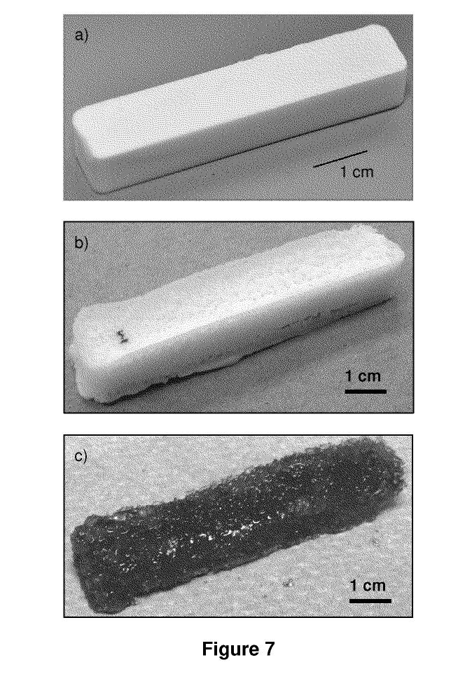

The co-continuous polymer blends can be prepared by melt extrusion, a typical large-scale production process for polymer materials. The inventors have obtained co-continuous granules or pellets. The pellets can be subsequently molded by injection to obtain starting co-continuous polymer materials of various sizes and shapes. Various cutting/milling/polishing/piercing mechanical tools and equipments can also be used to shape the materials. For example, the inventors have molded PS/PLA bars (FIG. 7a: the dimensions are 0.95 cm×1.25 cm×6.3 cm). The steps, namely, quiescent annealing followed by material shaping, polymer extraction, gel injection and extraction of the mold can subsequently be performed (FIG. 7b and c).

7. Freeze-Drying of the Porous Gels for the Preparation of Aerogels (Example 7)

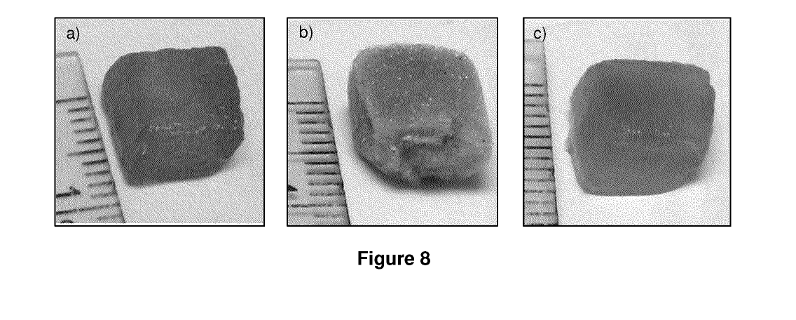

The porous gel obtained can be subsequently freeze-dried if needed. FIG. 8 demonstrates that the macroscopic dimensions are nearly unchanged after freeze-drying, resulting in an aerogel. Subsequent rehydration yields a porous gel with unchanged macroscopic dimensions.

8. Porous gels prepared with 3-D printed porous polymer molds (Example 8)

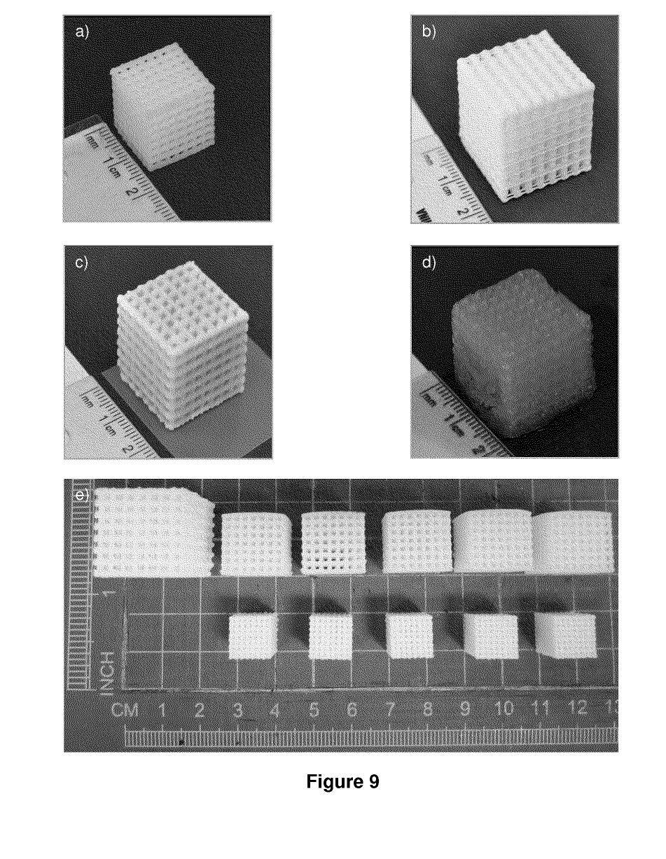

Additive manufacturing (AM) or 3-D polymer printing can be used as an alternative to co-continuous polymer blends to fabricate the porous polymer molds. FIG. 9 illustrates three polylactide (PLA) porous templates prepared by 3-D printing. In (a), the mold has a cubic shape (3.375 cm³) with 1 mm pore size and around 1 mm polymer mesh size. In (b), the mold has a cubic shape (8 cm³) with 1.5 mm pore size and around 1.5 mm polymer mesh size. In (c), the PLA mold displayed in (b) has been filled with a sodium alginate solution (in blue) subsequently cross-linked in situ by plunging the filled cube in a calcium chloride solution. Since the pores of the porous polymer template are interconnected, i.e., the porosity is continuous through the volume of the template, the entire porosity is filled with the solution. In (d), the PLA mold has been extracted with chloroform, leaving a porous alginate gel with similar dimensions to the original mold, and pore size of about 1.5 mm. Cubes with 0.5 mm pores were also prepared with this method (FIG. 9e). Gels with higher pore sizes can be prepared with this method. This method allows for the preparation of a template outlining a unimodal distribution set at a predefined target pore diameter if needed.

As will be understood by a skilled person, injection of the precursor solution within the porous polymer template generated by additive manufacturing is performed as described herein above for example at point 4, and subsequent extraction of the polymer material after in situ gelling to obtain the porous gel is performed as described herein above for example at point 5.

Also as will be understood by a skilled person, a porous gel obtained using a porous polymer template generated by additive manufacturing can be subjected to freeze-drying as described herein above for example at point 7.

The porous gel obtained by the method according to the invention comprises a 3-D fully interconnected pore network throughout its volume. A total void or pore volume fraction of the porous gel is about 10 to more than 90 vol %. It can also be between about 40 and about 60 vol %.

The porous gel of the invention has an average pore size diameter of about 0.5 μm to about 3.0 mm. The average pore size diameter can also be between about 1 μm and about 1.5 mm.

The porous gel of the invention may have a complex 3-D microstructure.

If a gradient temperature is applied during the annealing step, the porous gel of the invention may have a gradient average pore size.

The porous gel of the invention can be used in various applications including but not limited to the following: as material for supporting cell development, as materials for the development of new therapeutic drugs (for example anticancer drugs), for controlled-delivery of substances encapsulated within the gel, as membranes, as filtration or separation material, as material for reproducing natural structures.

As will be understood by a skilled person, embodiments of the method according to the invention lead to the preparation of a system consisting of a porous polymer template and gel. The system is obtained after injection of the precursor solution in the template and subsequent gel of the solution. The porous polymer template and gel system thus obtained can be subjected to a freeze-dry process. Also, the freeze-dried system can further be subjected to hydration. Moreover, the porous polymer template and gel system or the freeze-dried porous polymer template and gel system subsequently hydrated can be subjected to an extraction process for extraction of at least part of the polymer material. The porous polymer template and gel system can be used in various applications similarly to the porous gel, as described above.

Although the present invention has been described hereinabove by way of specific embodiments thereof, it can be modified, without departing from the spirit and nature of the subject invention as defined in the appended claims.

The present description refers to a number of documents, the content of which is herein incorporated by reference in their entirety.

### REFERENCES

1. Huang G Y et al. (2011) Microfluidic Hydrogels for Tissue Engineering. Biofabrication, 3, 012001.
2. Slaughter B V et al. (2009) Hydrogels in Regenerative Medecine. Advanced Materials, 21, 3307-3329.
3. Vlierberghe S V et al. (2011) Biopolymer-Based Hydrogels as Scaffolds for Tissue Engineering Applications: A Review. Biomacromolecules, 12, 1387-1408.
4. Yang Q et al. (2011) Composites of functional polymeric hydrogels and porous membranes. Journal of Materials Chemistry, 21, 2783-2811.
5. Lozinsky V I et al. (2003) Polymeric Cryogels as Promising Materials of Biotechnological Interest. Trends in Biotechnology, 21, 445-451.
6. Stachowiak A N et al. (2005) Bioactive Hydrogels with an Ordered Cellular Structure Combine Interconnected Macroporosity and Robust Mechanical Properties. Advances Materials, 17, 399-403.
7. Lu H et al. (2010) Cartilage Tissue Engineering using Funnel-like Collagen Sponges Prepared with Embossing Ice Particulate Templates. Biomaterials, 31, 5825-5835.
8. Lévesque S G et al. (2005) Macroporous Interconnected Dextran Scaffolds of Controlled Porosity for Tissue-Engineering Applications. Biomaterials, 26, 7436-7446.
9. Elbert D L (2011) Liquid-liquid Two-Phase Systems for the Production of Porous Hydrogels and Hydrogel Microspheres for Biomedical Applications: A Tutorial Review. Acta Biomaterialia, 7, 31-56.
10. Barbetta A et al. (2010) Porous Gelatin Hydrogels by Gas-in-Liquid Foam Templating. Soft Matter, 6, 1785-1792.
11. Ji C et al. (2011). Fabrication of Porous Chitosan Scaffolds for Tissue Engineering Using Dense Gas CO₂. Acta Biomaterialia, 7, 1653-1664.
12. Vlierberghe S V et al. (2007) Porous Gelatin Hydrogels: 1. Cryogenic Formation and Structure Analysis. Biomacromolecules, 8, 331-337.
13. Gauvin R et al. (2012) Microfabrication of Complex Porous Tissue Engineering Scaffolds Using 3D Projection Stereolithography. Biomaterials, 33, 3824-3834.
14. Khademhosseini K and Langer R (2007) Microengineered Hydrogels for Tissue Engineering. Biomaterials, 28, 5087-5092.
15. Bryant S J et al. (2007) Photo-Patterning of Porous Hydrogels for Tissue Engineering. Biomaterials, 28, 2978-2986.
16. Cabodi M et al. (2005) A Microfluidic Biomaterial. Journal of the American Chemical Society, 127, 13788-13789.
17. Tang M D et al. (2003) Molding of Three-Dimensional Microstructures of Gels. Journal of the American Chemical Society, 125, 12988-12989.
18. Billiet T et al. (2012) A Review of Trends and Limitations in Hydrogel-Rapid Prototyping for Tissue Engineering. Biomaterials, 33, 6020-6041.
19. Li J et al. (2002) The Role of the Blend Interface Type on Morphology in Cocontinuous Polymer Blends. Macromolecules, 35, 2005-2016.
20. Galloway J A et al. (2005) Block Copolymer Compatibilization of Cocontinuous Polymer Blends. Polymer, 46, 183-191.
21. Virgilio N et al. (2010) Towards Ultraporous Poly(L-lactide) Scaffolds from Quaternary Immiscible Polymer Blends. Biomaterials, 31, 5719-5728.
22. Zhang J et al. (2007) Ultralow Percolation Thresholds in Ternary Cocontinuous Polymer Blends. Macromolecules, 40, 8817-8820.
23. Sarazin P et al. (2004) Controlled Preparation and Properties of Porous Poly(L-lactide) Obtained from Co-continuous Blend of Two Biodegradable Polymers. Biomaterials, 25, 5965-5978.
24. Yao D G et al. (2009) Controllable Growth of Gradient Porous Structures. Biomacromolecules, 10, 1282-1286.
25. U.S. pat. No. 8,007,823; U.S. Pat. No. 8,257,624; U.S. 2004/0062809.
26. U.S. Pat. No. 6,511,650; U.S. Pat. No. 6,608,117; U.S. Pat. No. 6,793,675; U.S. 2004/0062809; U.S. 2004/0147016; U.S. 2007/0248642; U.S. 2010/0221303, U.S. 2011/0008442.
27. Li J et al. (2001) Characterizing co-continuous high density polyethylene/polystyrene blends. Polymer, 42, 5047-5053.
28. Galloway et al. (2002) Image analysis for interfacial area and cocontinuity detection in polymer blends. Polymer, 43, 4715-4722.

1. A method for preparing a porous gel, comprising the steps of:
(a) providing a porous polymer template;
(b) injecting a precursor solution in the template, wherein the solution subsequently gels and a porous polymer and gel system is obtained; and
(c) subjecting the porous polymer and gel system to an extraction process, wherein at least part of the polymer material is extracted and the porous gel is obtained.

2. The method according to claim 1, wherein step (a) comprises the steps of:
(a1)) preparing a co-continuous mixture of polymer material to obtain a polymer blend;
(a2) annealing the polymer blend; and
(a3) selectively extracting a portion of the polymer material to obtain the porous polymer template.

3. A method according to claim 2, wherein the polymer material comprises at least two polymers, the portion of the polymer material at step (a3) comprises one polymer and the polymer material at step (c) comprises at least one of the other polymers.

4. A method for preparing a porous gel, comprising the steps of:
(a1) preparing a co-continuous mixture of at least two polymers to obtain a polymer blend;
(a2) annealing the polymer blend;
(a3) selectively extracting at least one polymer to obtain the porous polymer template;
(b) injecting a precursor solution in the template, wherein the solution subsequently gels and a porous polymer and gel system is obtained; and
(c) subjecting the porous polymer and gel system to an extraction process, wherein at least part of the polymer material is extracted and the porous gel is obtained.

5. A method for preparing a porous gel, comprising the steps of:
(a1) preparing a co-continuous mixture of first and second polymers to obtain a polymer blend;
(a2) annealing the polymer blend;
(a3) selectively extracting the first polymer to obtain the porous polymer template;
(b) injecting a precursor solution in the template, wherein the solution subsequently gels and a porous polymer and gel system is obtained; and
(c) subjecting the porous polymer and gel system to an extraction process, wherein at least part of the polymer material is extracted and the porous gel is obtained.

6. The method according to claim 1, wherein step (a) comprises generating the porous polymer template by additive manufacturing (AM) or 3-D printing.

7. A method for preparing a porous gel, comprising the steps of:
(a) generating a porous polymer template by additive manufacturing (AM) or 3-D printing;
(b) injecting a precursor solution in the template, wherein the solution subsequently gels and a porous polymer and gel system is obtained; and
(c) subjecting the porous polymer and gel system to an extraction process, wherein at least part of the polymer material is extracted and the porous gel is obtained.

8. The method according to any one of claims 2 to 5, wherein step (a2) is performed under quiescent conditions.

9. The method according to any one of claims 2 to 5, wherein step (a2) is performed under a constant temperature.

10. The method according to any one of claims 2 to 5, wherein step (a2) is performed under a gradient temperature.

11. The method according to any one of claims 1 to 7, wherein step (b) comprises removing air from pores of the template.

12. The method according to claim 11, wherein step (b) comprises applying vacuum and/or pressure.

13. The method of claim 1, wherein at step (c), the polymer material is completely extracted and the porous gel obtained is substantially free of the polymer material.

14. The method of claim 1, wherein at step (c), the polymer material is partially extracted and the porous gel obtained comprises the polymer material.

15. The method according to any one of claims 1 to 14, further comprising the step of: (d) freeze-drying the porous gel obtained.

16. The method according to any one of claims 1, 2, 6 and 7, wherein polymers in the polymer material are selected from: polystyrene (PS), poly(methyl methacrylate) (PMMA), poly(D, L or DL)lactide (PLA), polycaprolactone (PCL), polyethylene oxide (PEO), polyethylene glycol (PEG), polypropylene (PP), polyethylene (PE), high density polyethylene (HDPE), low density polyethylene (LDPE), linear low density polyethylene (LLDPE), polybutadiene (PBD), ethylene-propylene rubber (EPR), ethylene-propylene-diene monomer (EPDM), polycarbonate (PC), polyamides (PA), polyglycolide (PGA), polyvinyl alcohol (PVOH or PVA), polyvinyl acetate (PVAc), polysiloxanes, polyethylene terephthalate (PET), styrene-acrylonitrile copolymers (SAN), polyvinylidene fluoride (PVDF), polybutylene succinate (PBS), polyether amides (PEBA), acrylonitrile butadiene styrene (ABS), polyhydroxyalcanoates, polyesters, polyanhydrides, copolymers thereof, atactic forms thereof when applicable, isotactic forms thereof when applicable, syndiotactic forms thereof when applicable, and stereoisomers thereof when applicable.

17. The method according to any one of claims 2 to 5, wherein the polymers are selected from: polystyrene (PS), poly(methyl methacrylate) (PMMA), poly(D, L or DL)lactide (PLA), polycaprolactone (PCL), polyethylene oxide (PEO), polyethylene glycol (PEG), polypropylene (PP), polyethylene (PE), high density polyethylene (HDPE), low density polyethylene (LDPE), linear low density polyethylene (LLDPE), polybutadiene (PBD), ethylene-propylene rubber (EPR), ethylene-propylene-diene monomer (EPDM), polycarbonate (PC), polyamides (PA), polyglycolide (PGA), polyvinyl alcohol (PVOH or PVA), polyvinyl acetate (PVAc), polysiloxanes, polyethylene terephthalate (PET), styrene-acrylonitrile copolymers (SAN), polyvinylidene fluoride (PVDF), polybutylene succinate (PBS), polyether amides (PEBA), acrylonitrile butadiene styrene (ABS), polyhydroxyalcanoates, polyesters, polyanhydrides, copolymers thereof, atactic forms thereof when applicable, isotactic forms thereof when applicable, syndiotactic forms thereof when applicable, and stereoisomers thereof when applicable.

18. The method according to claim 5, wherein the first polymer is selected from polystyrene (PS), poly(methyl methacrylate (PMMA), ethylene-propylene rubber (EPR), polycaprolactone (PCL), and polyethylene oxide (PEO).

19. The method according to claim 5, wherein the second polymer is selected from poly(D, L or DL)lactide (PLA), polyethylene (PE), poly(methyl methacrylate (PMMA), polycaprolactone (PCL), polyvinyl alcohol (PVOH or PVA), polyethylene oxide (PEO), and styrene-acrylonitrile copolymer (SAN).

20. The method according to claim 5, wherein the first polymer is polystyrene and the second polymer is polylactide.

21. The method according to claim 5, wherein a combination first polymer/second polymer is selected from: polystyrene/polyethylene, poly(methyl methacrylate)/polyethylene, polystyrene/poly(methyl methacrylate), ethylene-propylene rubber/poly(methyl methacrylate), ethylene-propylene rubber/polyethylene, polycaprolactone/polylactide, polyethylene oxide/polycaprolactone, polyethylene oxide/polyvinyl alcohol, poly(methyl methacrylate)/polylactide, polyethylene oxide/polylactide, polycaprolactone/polyvinyl alcohol, polystyrene/polycaprolactone, polystyrene/polyethylene oxide, poly(methyl methacrylate)/styrene-acrylonitrile copolymer, and poly(butylene succinate)/polyethylene oxide.

22. The method according to claim 5, wherein the first and second polymers are used in a proportion of about 50/50 vol %.

23. The method according to any one of claims 2 to 5, wherein the extraction solvents at steps (a3) and (c) are selected from: cyclohexane, benzoic acid, chloroform, dichloromethane, toluene, hexane, acetone, ethanol, methanol, water, hydrochloric acid, 1-propanol, acetic acid, sulfuric acid, benzene, tetrahydrofuran, 1,4-dioxane, isopropanol, dimethylformamide, nitric acid, pentane, cyclopentane, diethyl ether, ethyl acetate, acetonitrile, dimethyl sulfoxide, formic acid, 1-butanol, 2-butanol, petroleum ether, heptane, methyl tert-butyl ether, tert-butanol, methylbutylacetone, isobutanol, butanone, isopentyl alcohol, diethyl acetone, 1-octanol, p-xylene, m-xylene, o-xylene, dimethoxyethane, ethylene glycol, glycerol, and mixtures thereof.

24. The method according to any one of claims 2 to 5, wherein the extraction solvent at step (a3) is selected from water, toluene, cyclohexane and mixtures thereof; and the extraction solvent at step (c) is chloroform or water.

25. The method according to any one of claims 2 to 5, wherein the extraction solvent at step (a3) is cyclohexane, and the extraction solvent at step (c) is chloroform.

26. The method according to any one of claims 1 to 5, wherein the precursor solution comprises a precursor agent selected from: natural macromolecules (polysaccharides, proteins, gums and their combinations, etc.), synthetic macromolecules (polyacrylates, polyacrylamides, associative polymers, polydimethylsiloxanes, etc.), low molecular weight gelators (fatty acid derivatives, steroid derivatives, sugar-based derivatives, etc.), low molecular weight molecules that react to form molecular networks (such as epoxides), low molecular weight molecules that react to form fibrillar networks (for example 12-hydroxyoctadecanoic acid) or networks of micro/nano-particles (sodium silicate, tetraorthosilicate, aluminum hydroxide, etc.).

27. The method according to any one of claims 1 to 5, wherein the precursor solution is selected from: solutions of water with natural polymers, solutions of water with synthetic monomers and/or polymers, solutions of organic liquids with low molecular weight gelators, monomers or polymers, solutions or liquids containing molecules that can react to form molecular networks, fibrillar networks or networks of micro/nano-particles, and mixtures thereof.

28. The method according to any one of claims 1 to 5, wherein the porous gel is a physically cross-linked gel (ex. agar), an ionically or physico-chemically cross-linked gel (ex. alginate), a chemically cross-linked gel (ex. poly(hydroxyethyl methacrylate)), poly(N-isopropylacrylamide), a hydrogel, an organogel, or a combination thereof.

29. The method according to any one of claims 2 to 5, wherein step (a) further comprises subjecting the polymer blend to a step of shaping and/or molding between steps (a1) and (a2).

30. The method of claim 1, wherein a distribution of pore diameters of the gel is controlled by a porous polymer template selection.

31. The method according to claim 1, wherein the porous polymer template has a distribution of pore diameters that is unimodal.

32. A method for preparing a porous polymer and gel system, comprising the steps of:
(a) providing a porous polymer template; and
(b) injecting a precursor solution in the template, wherein the solution subsequently gels and the porous polymer and gel system is obtained.

33. The method according to claim 32, further comprising the step of: (c1) subjecting the porous polymer and gel system obtained at step (b) to an extraction process, wherein the polymer material is partially extracted.

34. The method according to claim 32 or 33, further comprising the step of: (d) freeze-drying the porous polymer and gel system obtained.

35. The method according to claim 34, further comprising subjecting the freeze-dried porous polymer and gel system to hydration, and then subjecting the system to one or more further extraction processes, wherein at least part of the polymer material is extracted.

36. A porous gel obtained by the method as defined in any one of claims 1 to 31.

37. The porous gel according to claim 36, which comprises a 3-D fully interconnected pore network throughout its volume.

38. The porous gel according to claim 36 or 37, wherein a total void or pore volume fraction is about 10 to more than 90 vol %.

39. The porous gel according to claim 36 or 37, wherein a total void or pore volume fraction is between about 40 and about 60 vol %.

40. The porous gel according to claim 36 or 37, having an average pore size diameter ranging from about 0.5 μm to about 3.0 mm.

41. The porous gel according to claim 36 or 37, having an average pore size diameter ranging from about 1 μm to about 1.5 mm.

42. The porous gel obtained by the method as defined in claim 10, having a gradient average pore size.

43. The porous gel obtained by the method as defined in claim 31, having a distribution of pore diameters that is unimodal.

44. Use of the porous gel as defined in any one of claims 36 to 43, as material for supporting cell development.

45. Use of the porous gel as defined in any one of claims 36 to 43, as a membrane or as filtration or separation material.

46. Use of the porous gel as defined in any one of claims 36 to 43, for reproducing natural structures (skin, bones).

47. Use of the porous gel as defined in any one of claims 36 to 43, as material for the development and testing of new therapeutic drugs (anticancer drugs).

48. Use of the porous gel as defined in any one of claims 36 to 43, for the controlled-delivery of a substance, wherein the substance is encapsulated therein.

49. Use of the porous gel obtained by the method as defined in claim 15, wherein the freeze-dried porous gel is subjecting to hydration prior to the use, and wherein the use of the porous gel is: as material for supporting cell development, as a membrane, as filtration or separation material, for reproducing natural structures (skin, bones), as material for the development and testing of new therapeutic drugs (anticancer drugs), or for the controlled delivery of a substance encapsulated therein.

50. A porous polymer and gel system obtained by the method as defined in any one of claims 32 to 35.

51. Use of the polymer and gel system obtained by the method as defined in any one of claims 32 to 35, in the development of materials for supporting cell development, membranes, filtration or separation materials, materials for the development and testing of new therapeutic drugs (anticancer drugs); in the process of reproducing natural structures (skin, bones); in the controlled-delivery process of an encapsulated substance.
